(19) United States
(12) Patent Application Publication
(10) Pub. No.: US 2008/0012498 A1
(43) Pub. Date: Jan. 17, 2008

(54) External Electrode Flourescent Lamp, Lighting Device, And Display Device

(75) Inventor: Yoshiki Takata, Mie (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka-shi, Osaka (JP)

(21) Appl. No.: 11/718,972

(22) PCT Filed: Oct. 18, 2005
(86) PCT No.: PCT/JP05/19069

§ 371 Date: May 9, 2007

(30) Foreign Application Priority Data
Nov. 17, 2004 (JP) 2004-332578

(51) Int. Cl. H01J 61/16; H01J 65/04

(52) U.S. Cl. 313/607; 313/643

(57) ABSTRACT

An external electrode fluorescent lamp has external electrodes at opposite ends. The portions provided with the external electrodes are bent so that their axes are orthogonal to the axis of a light emitting sections. A conventional external electrode fluorescent lamp is not bent in its portions provided with external electrodes. Since the external electrodes of the external electrodes fluorescent lamps serve concurrently as holding sections for the fluorescent lamps the axial length is made greater than the outer diameter so as to provide sufficient strength. The width of the frame section of the fluorescent lamp of the invention when mounted on a backlight unit is smaller than the width of the frame section of conventional fluorescent lamp. Therefore, the effective light emitting area of the backlight unit can be enlarged.

### BACKGROUND OF THE INVENTION

1. Field of the Invention

The present invention relates to an external electrode fluorescent lamp.

2. Description of the Related Art

An external electrode fluorescent lamp includes a linear glass tube having mercury or a rare gas filled therein with outer peripheral surfaces at the both ends thereof fitted with proximity conductors, silver paste, or the like as external electrodes. The external electrode fluorescent lamp, due to its structure of the electrodes provided outside, is said to be easy to process and capable of having a longer life. An example of such an external electrode fluorescent lamp is disclosed in Patent Document 1, JP-A-2003-168395 (see, in particular, FIGS. 2A, 2B, 3A, and 3B), described below. The invention described in Patent Document 1 relates to a structure for fitting the external electrode portion to a backlight unit.

In this invention, aluminum foil is first attached as an external electrode to both end sections of the glass tube, and then a holder with a slot having therein a holding plate for nipping the external electrode section is provided on a backlight unit side.

Proposed as having a simple structure, the structure is arranged such that the holding plate in the slot is electrically connected to a power source section via a connecting section. As a result, simply inserting the external electrode in the slot mechanically and electrically connects the lamp to the backlight unit side.

Patent Document 1, as just described, proposes the fitting structure that permits easily fitting the external electrodes as a holding section to the backlight unit side. The fitting of the external electrode fluorescent lamp is not limited to what is described in Patent Document 1. Thus, one basic structure of such a lamp has as a holding section external electrodes located at the both ends thereof.

In order to enlarge and improve viewability of the display area of a display screen of a display device, there have been in recent years attempts to enlarge the effective light emitting area of a backlight unit. In another words, there have been attempts to narrow down the frame of an external electrode section as a holding section located at the both sides of a lamp light-emitting section. One example of such attempts is indicated in Patent Document 2, JP-A-2004-200127 (see, in particular, FIG. 1), described below.

In Patent Document 2, from a viewpoint of its structure, the external electrodes as the lamp holding section are simply shortened to elongate the effective length of the light-emitting section to thereby narrow down the frame. In such a case, it is required to provide measures for obtaining sufficient tube current in accordance with the shortened length of the external electrodes. Such measures include: increasing the tube voltage; and increasing inverter transmission frequency. The latter measure is difficult to achieve due to limitations imposed on a transformer; therefore, the former measure, which attempts to increase the tube voltage, is applied in Patent Document 2.

However, this method requires application of a large tube voltage in order to obtain the required tube current, which consequently causes a new problem that ozone is generated by corona discharge.

Thus, in Patent Document 2, a starting device for applying a high-frequency voltage to the external electrodes at both ends of the lamp is finally provided as one component of a backlight unit, so that a high-frequency sine-wave voltage is applied across both electrodes. This permits application of a sine-wave voltage of a lower frequency than that provided in application of a rectangular-wave voltage, which in turn permits preventing ozone from being generated due to corona discharge from the electrodes.

Also in Patent Document 2, the external electrode fluorescent lamp is fitted to the backlight unit such that, as in Patent Document 1 described above, an external electrode portion is held by a holding plate connected to a power source section.

In Patent Document 2 described above, to ensure the current required as a result of shortening the external electrodes for the purpose of narrowing down the frame, the starting device for high-frequency voltage application is provided. This, however, leads to increasing the size of the backlight unit, which goes against the recent demands for size and weight reduction in any field.

In terms of mechanical strength, the external electrodes also serving as the holding section cannot be shortened thoughtlessly. In order to reduce a voltage to provide a larger current flow in response to demands for higher brightness, there is also a trend toward increasing the length of the external electrodes.

### SUMMARY OF THE INVENTION

In order to overcome the problems described above, preferred embodiments of the present invention provide an external electrode fluorescent lamp having an enlarged effective light emitting area and narrowed frame of a backlight unit fitted with an external electrode fluorescent lamp.

A preferred embodiment of the present invention provides an external electrode fluorescent lamp having external electrodes at both ends thereof such that at least one of tube axes of external electrode sections having the external electrodes is substantially perpendicular to a tube axis of a light-emitting section.

As a result, from viewpoints of strength as a holding section, the length of the external electrode along the tube axis is usually set so as to be longer than the outermost diameter dimension of the external electrode. In preferred embodiments of the present invention in which the external electrode is oriented perpendicularly to the tube axis and the lamp is held at this portion, in a case where the lamp is applied to a backlight unit of a display device such as a liquid crystal display device or the like, the outermost diameter dimension of the external electrode corresponds to a width dimension of a frame section. Thus, under the same shape and area condition of the lamp fitting surface of the backlight unit, the size of the frame section can be reduced to a greater degree compared to the case where the external electrode along the tube axis is provided as a holding section. Therefore, the effective light emitting area of the backlight unit can be enlarged.

With a configuration such that a lamp tube has a substantially annular rectangle configuration with the opposite short sides thereof respectively provided with external electrodes, upon holding the lamp at each of the both frame sections (external electrode sections) by using it for a backlight of a display device, the lamp which has been originally provided in two holders can be held with one holder so that the effective light emitting area of the backlight unit can be enlarged, the number of components can be reduced, and labor of fitting the lamp can be cut in half, compared to a conventional case where the external electrodes of two lamps are individually held and thus two holders are required.

In addition to the configuration described above, with a configuration such that the inside of the lamp tube is partitioned by a wall at position of each of the opposite short sides included in the external electrodes and thus divided into two discharge gas spaces so that each of the external electrodes acts on the two discharge gas spaces, a positive column can be reliably generated in the two gas spaces, compared to a case where no partition is provided.

In the lamp having the unique configuration described above, a method of obtaining fluorescent visible light by enclosing mercury and utilizing ultraviolet emission thereof is the most typical method with highest emission efficiency. Therefore, this typical method permits achieving low cost, and the high emission efficiency permits providing a display device with low power consumption and high brightness.

Enclosing xenon as gas at normal temperature instead of mercury as liquid at normal temperature results in a very favorable response without temperature characteristics and, in terms of environmental responsiveness, further eliminates concerns about pollution due to its mercury-free property.

In a backlight unit of a display device provided with the external electrode lamp with the unique configuration described above, configuring a plurality of the external electrode lamps to be electrically connected together in parallel or substantially in parallel permits a more simplified drive circuit thereof than that provided by serial connection.

In a backlight unit of a display device provided with the external electrode lamp with the unique configuration described above, providing a chassis side electrode for supplying power to the external electrode fluorescent lamp with a form for holding the external electrode of the external electrode fluorescent lamp to hold the external electrode requires only one component for power supply to and holding of the external electrode lamp, which permits achieving cost saving for components and simplified assembly.

In the unique configuration described above, as the form for holding the external electrode, using a spring characteristic of metal to thereby nip and hold the external electrode permits a simplified structure.

In a display device provided with the backlight unit described above, configuring the external electrode section to have an external electrode arranged at an outer side beyond an active area of a display element locates a dark section of a non-light-emitting region outside, thereby permitting favorable light supply into the display active area. As a result, a very favorable quality level of the display device can be ensured.

In the display device provided with the backlight unit described above, installing a member for covering the external electrode section between the external electrode section and the display area locates the non-light-emitting section of the lamp inside the display active area, which permits hiding unevenness of the non-light-emitting section of the lamp even with the narrowest frame design.

As the member for covering the external electrode, a member which performs mirror reflection or scattering reflection can be used, which permits use of this light reflecting property to brighten the portion between the external electrode section and the display area to thereby ensure very favorable quality level as a display device.

The present invention having the unique configuration and features described above with respect to preferred embodiments permits narrowing down of the frame of a backlight unit, and thus, permits enlarging the effective light-emitting region under the same shape and area conditions of the lamp fitting surface of the backlight unit with a far more simple configuration, compared to a conventional, typical external electrode fluorescent lamp in which the tube axis of an external electrode section is coaxial with the tube axis of a light-emitting section, This largely contributes to the development in increasing the brightness of the backlight unit in the future.

Other features, elements, characteristics and advantages of the present invention will become more apparent from the following detailed description of preferred embodiments thereof with reference to the attached drawings.

### BRIEF DESCRIPTION OF DRAWINGS

FIG. 1 shows an external electrode fluorescent lamp according to a first preferred embodiment according to the present invention.

FIGS. 2A and 2B show an elevation view and a side view, respectively, of a conventional external electrode fluorescent lamp being fitted to a holder thereof.

FIGS. 3A and 3B are an elevation view and a plan view, respectively, of the external electrode fluorescent lamp according to a first preferred embodiment of the present invention being fitted to a holder thereof.

FIG. 4 shows advantages provided by preferred embodiments of the present invention in comparison with the conventional example.

FIGS. 5A and 5B respectively show an annular external electrode fluorescent lamp according to a second preferred embodiment of the present invention and a sectional view of the structure of the annular glass tube whose inside is partitioned by walls at positions where the external electrodes are formed.

FIGS. 6A to 6C show modified examples of an external electrode fluorescent lamp based on preferred embodiments of the present invention.

FIG. 7 is a longitudinal sectional view of the external electrode fluorescent lamp according to a preferred embodiment of the present invention which is included in a backlight of a liquid crystal display device.

### DETAILED DESCRIPTION OF PREFERRED EMBODIMENTS

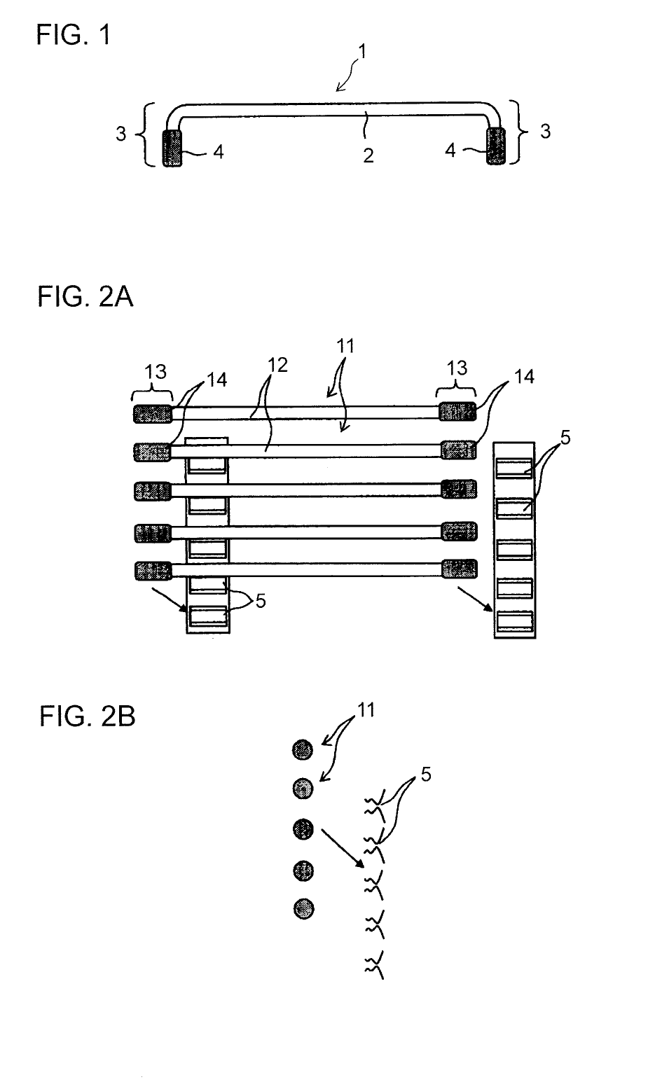

Hereinafter, referring to the drawings, preferred embodiments of the present invention will be described. For an external electrode fluorescent lamp (hereinafter also simply referred to as a lamp), an internal structure (including a filling) and electric configuration thereof, basic structure of a backlight unit loaded with the lamp, and the like are not essential matters of the present invention, and conventional examples and general matters of an external electrode fluorescent lamp is directly applicable to the external electrode fluorescent lamp of the present invention. Thus, these overlapping contents will be omitted from description and illustration. FIG. 1 shows the lamp, as a separate unit, of a first preferred embodiment of the present invention.

As shown in FIG. 1, the lamp 1 of this preferred embodiment preferably includes: a light-emitting section 2 with a linear tube axis; and external electrode sections 3 which are located at the both ends of the light-emitting section and which are perpendicular or substantially perpendicular to the tube axis of the light-emitting section 2. The tube axes of the external electrode sections 3 at the both ends are oriented in the same direction, which is illustrated as downward in the drawing. On the outer peripheral surface of this external electrode section 3, an external electrode 4 is fitted. The external electrode 4 may be a proximity conductor, silver paste, metallic foil (aluminum foil), or the like.

The external electrode section 3 of the lamp 1 with such a configuration is fitted to a holder provided in an external electrode region of a backlight unit. FIGS. 2A and 2B show, for comparison with preferred embodiments of the present invention, an elevation view and a side view, respectively, of a conventional external electrode fluorescent lamp being fitted to a holder thereof. In the figure, for discrimination from the lamp 1 of the present preferred embodiment of the present invention, a lamp of the conventional example is referred to with numeral 11, a light-emitting section thereof is referred to with numeral 12, an external electrode section thereof is referred to with numeral 13, and an external electrode is referred to with numeral 14.

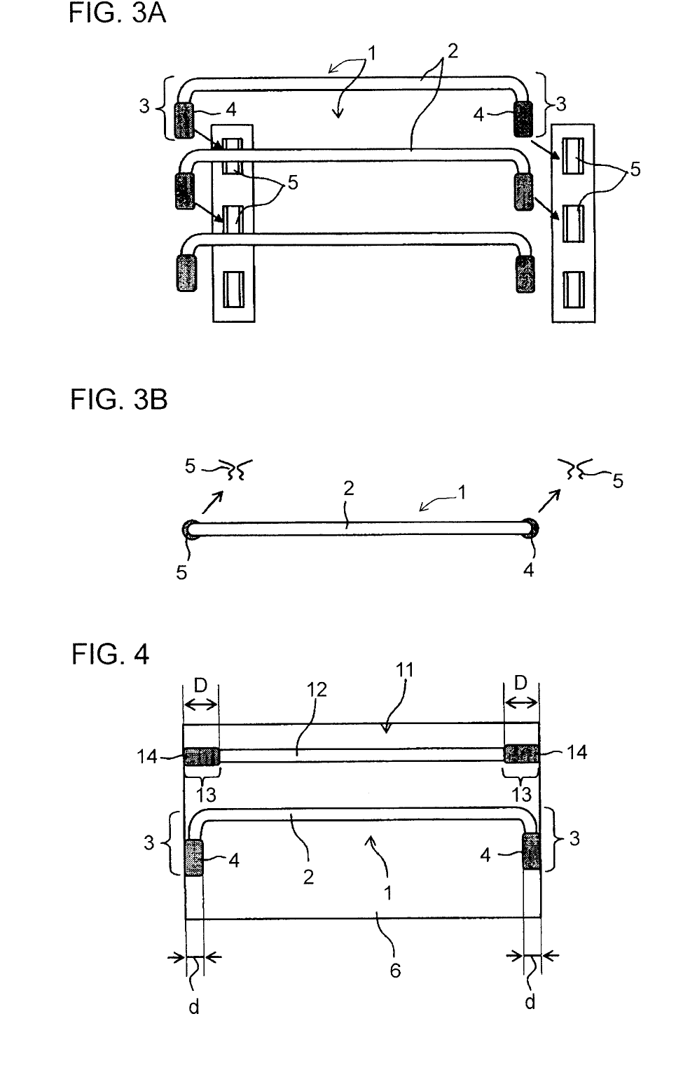

FIGS. 3A and 3B show an elevation view and a plane view, respectively, of the lamp 1 according to the present preferred embodiment being fitted to the holder for comparison with the conventional example. The structure of the holder for the lamp is common between the present preferred embodiment and the conventional example and thus commonly provided with numeral 5.

The holder 5 shown in FIGS. 2 and 3 nips the external electrode of one lamp with a spring property provided by two spring steel plates combined together in both the conventional example and the present preferred embodiment of the present invention. This holder 5 is provided in the same number as that of lamps in parallel thereto.

In the conventional example, the tube axis of the external electrode section 13 and the tube axis of the lamp 11 are parallel to (coaxial with) each other. Thus, as shown in FIG. 2, when the light-emitting section 12 of the lamp 11 of the conventional example is horizontally disposed, the tube axis of the external electrode section 13 is horizontally oriented.

On the other hand, in the lamp of the present preferred embodiment, as shown in FIG. 1, the tube axis of the external electrode section 3 is perpendicular or substantially perpendicular to the tube axis of the light-emitting section 2. Thus, when the light-emitting section 2 of the lamp 1 is disposed horizontally, the tube axis of the external electrode section 3 is directed perpendicularly downward or substantially perpendicularly downward.

Referring to FIG. 4, comparison is provided for an effective light emitting area between the lamp of the present preferred embodiment having the unique configuration as described above and the lamp of the conventional example. FIG. 4 schematically shows the lamp of the conventional example and the lamp 1 of the present preferred embodiment fitted to the holder of the backlight unit under the same shape and area conditions of the lamp fitting region. To avoid complicatedness of the drawing, only a rectangular frame 6 indicating a region on the backlight unit side where the lamp is fitted is shown, and components, such as a holder, and the like, actually located are all omitted from illustration.

As shown in FIG. 4, when the lamp 1 of the present preferred embodiment and the lamp 11 of the conventional example are fitted to the backlight unit under the same shape and area condition, the size of the frame section in the present preferred embodiment is a maximum outer diameter d of the external electrode 4 while the size of the frame section in the conventional example is an axial size D of the external electrode 14.

The lengths of the external electrodes 4 and 14 along the tube axis, from viewpoints of strength as a holding section, are so set as to be longer than the outermost diameters of the external electrodes 4 and 14. Therefore, use of the lamp of the present preferred embodiment permits a larger effective light-emitting area of the backlight unit than the area provided by use of the lamp 11 of the conventional example.

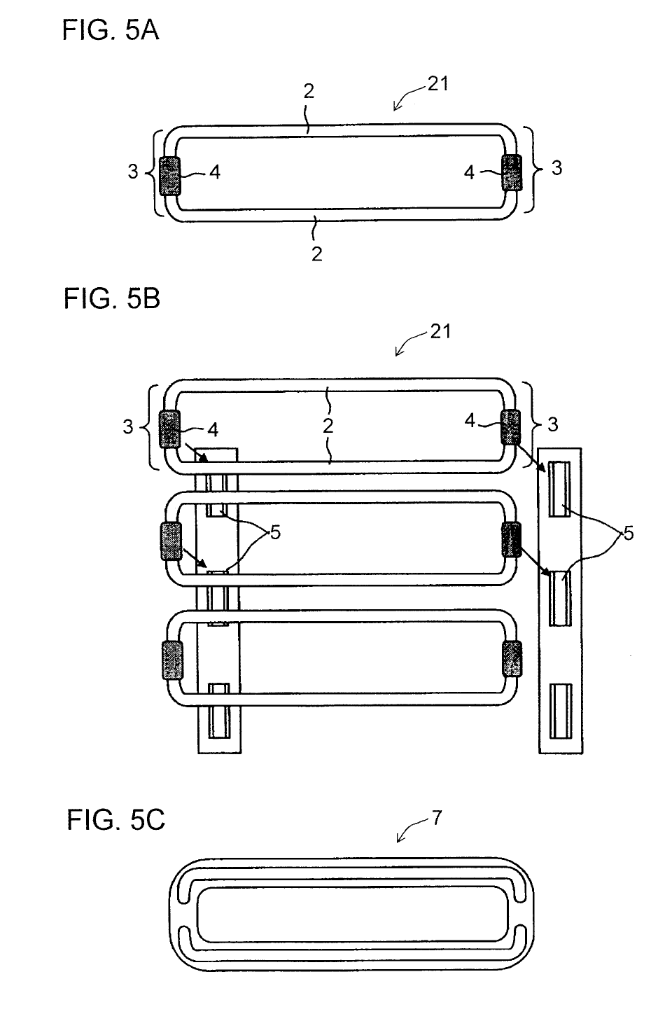

Next, a second preferred embodiment of the present invention will be described. FIG. 5A shows external appearance of an external electrode fluorescent lamp 21 of the second preferred embodiment. This lamp 21, as shown in the figure, is formed with a glass tube that preferably has the shape of an annular rectangle having external electrodes formed on the outer peripheral surfaces at the opposite short sides thereof fitted with proximity conductors, silver paste, metallic foil, or the like.

When the annular lamp 21 described above is applied for use in a backlight unit, at each of the both frame sections (external electrode sections) of the backlight unit, it becomes possible to hold, with a single holder, the lamp 1 which has been originally divided into two by retaining an external electrode 14 arranged into a single electrode by joining the two together. Therefore, this permits enlarging the effective light emitting area of the backlight unit and also permits reducing the number of components used, compared to a case where the two external electrodes 4 of the lamp 1 are individually held and thus two holders are required. Moreover, a labor of fitting a lamp is reduced by half, thereby improving the assembly efficiency.

Further, when this lamp is enclosed with mercury therein, a labor of detaching the lamp is also reduced. This permits safely and easily performing the disassembly of a lighting device or the like using this lamp and forwarding it to recycling and disposal processes, thus greatly satisfying strong recent social demands for environmental protection.

Also using the holder 5 as an electrode of a chassis for supplying power to the lamps 1 and 21, although not shown, contributes to reducing the number of components and enhancing the assembly efficiency, compared to a case where they are separately formed.

Next, FIG. 5B schematically shows a sectional view of the inside of a glass tube, in the annular external electrode fluorescent lamp 21 of FIG. 5A, which tube is structured with walls formed at the position of the opposite short sides of the rectangle where the external electrodes are formed. As shown in FIG. 5B, the glass tube 7 of the present preferred embodiment has the annular inside thereof partitioned into two separate discharge gas spaces by the glass walls and thus electrically separated from each other, thereby providing structure that permits reliably generating positive columns in the respective discharge gas spaces.

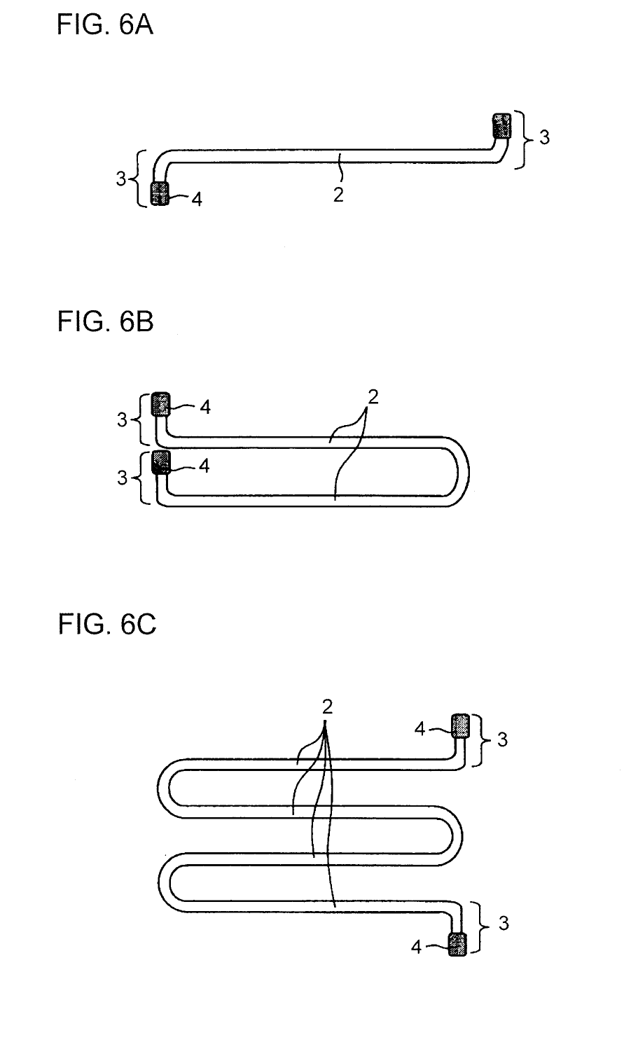

FIGS. 6A to 6C show modified examples of a discharge lamp according to another preferred embodiment of the present invention. In these figures, various forms of the light-emitting section 2 are provided, for example, the one with a curve or with a plurality of such curves, but what is common among them is that, when they are loaded in a backlight unit, the tube axis of the external electrode 4 also serving as a lamp support section is perpendicular or substantially perpendicular to the tube axis of the lamp 1 extending in a main disposition direction of the light-emitting section 2 (horizontal direction in the figures) and that the effective light-emitting region is far more enlarged than a conventional one in which the tube axis of the external electrode 4 is equal to the tube axis of the lamp 1 extending in the main disposition direction of the light-emitting section 2.

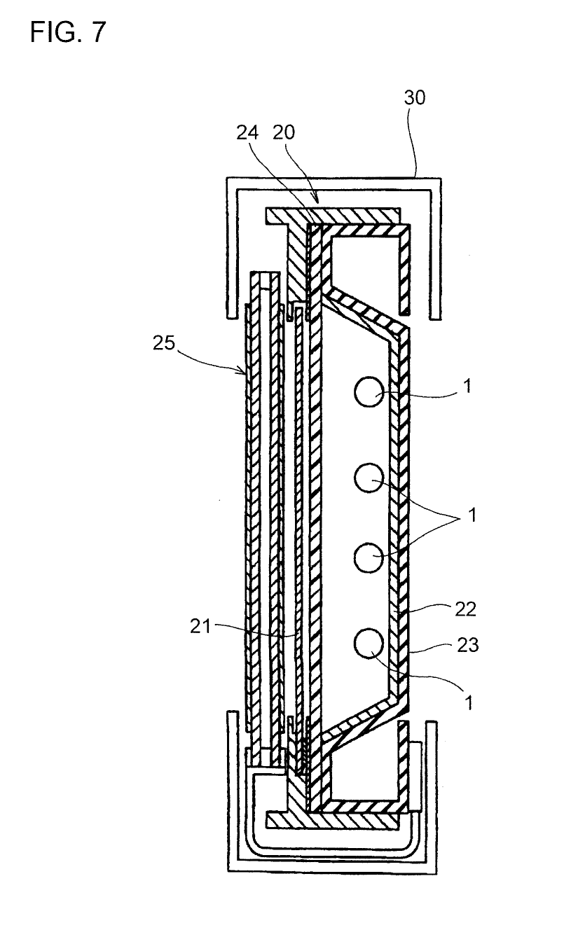

Although the external electrode fluorescent lamp alone according to various preferred embodiments of the present invention has been described above, FIG. 7 shows one example of application to a backlight as a lighting device for a liquid crystal display device. A preferred embodiment of the external electrode fluorescent lamp of the present invention used for the backlight of this liquid crystal display device corresponds to the preferred embodiment shown in FIG. 3. FIG. 7 is a longitudinal sectional view of a liquid crystal display device having as a backlight a display lighting device fitted with the external electrode fluorescent lamp shown in FIG. 3.

As shown in FIG. 7, in this liquid crystal display device, a backlight 20 having an optical sheet 21 on the exit surface side and a liquid crystal panel 25 are nipped by a bezel 30 of metal.

The backlight 20 has four external electrode fluorescent lamps shown in FIG. 3 arranged at equal intervals immediately below the liquid crystal panel 25 on the rear side with the tube axis of a main section thereof (light-emitting section 2) oriented horizontally. Then, a case 23 that is formed as to be substantially concave in cross section and fitted with the reflection sheet 22 on the inner circumferential surface thereof covers the rear surface of the fluorescence lamp 1. Moreover, between the fluorescence lamp 1 and the optical sheet 21, a diffuser 24 is arranged so as to reduce variance in light from the fluorescence lamp 1.

Fitting of the fluorescence lamp 1 to the concave case 23 is not illustrated in this FIG. 7 but is embodied as shown in FIG. 3A. That is, to the right and left side sections when the concave case 23 is viewed from the front, the holder having the plates of spring steel combined together are fitted. To this holder, the fluorescence lamp 1 of FIG. 3A is fitted such that the fitting section (external electrode section) curved in a direction that is perpendicular or substantially perpendicular to the tube axis of the main body is nipped.

The external electrode fluorescent lamp according to various preferred embodiments of the present invention is applicable to general backlight units for use in a transmission type liquid crystal display device and the like.

While preferred embodiments of the present invention have been described above, it is to be understood that variations and modifications will be apparent to those skilled in the art without departing from the scope and spirit of the present invention. Thus, the scope of the present invention is to be determined solely by the following claims.

1. An external electrode fluorescent lamp comprising external electrodes at both ends thereof, wherein at least one of tube axes of external electrode sections comprising the external electrodes is substantially orthogonal to a tube axis of a light-emitting section.

2. An external electrode fluorescent lamp so formed as to comprise external electrodes respectively at opposite short sides of an annular rectangle of a lamp tube.

3. The external electrode fluorescent lamp according to claim 2, wherein inside of the lamp tube is partitioned by a wall at position of each of the opposite short sides included in the external electrodes and thus divided into two discharge gas spaces so that each of the external electrodes acts on the two discharge gas spaces.

4. The external electrode fluorescent lamp according to claim 1, wherein mercury is enclosed.

5. The external electrode fluorescent lamp according to claim 1, wherein xenon is enclosed.

6. A display device lighting device comprising the external electrode fluorescent lamp according to claim 1.

7. The display device lighting device according to claim 6, being used as a direct-type backlight light source of a display device.

8. The display device lighting device according to claim 6, having a plurality of the external electrode fluorescent lamps, wherein the plurality of external electrode lamps are electrically connected together in parallel.

9. The display device lighting device according to claim 6, wherein a chassis side electrode for supplying power to the external electrode fluorescent lamp has a form for holding the external electrode of the external electrode fluorescent lamp to thereby hold the external electrode.

10. The display device lighting device according to claim 9, wherein as the form for holding the external electrode, a spring characteristic of metal is used to thereby nip and hold the external electrode.

11. A display device comprising the lighting device according to claim 6.

12. The display device according to claim 11, wherein the external electrode section has the external electrode arranged at an outer side than an active area of a display element.

13. The display device according to claim 11, wherein a member for covering the external electrode section is installed between the external electrode section and a display area.

14. The display device according to claim 11, wherein the external electrode section is so designed to have the external electrode arranged at an outer side than an active area of a display element, and wherein a member for covering the external electrode section is installed between the external electrode section and a display area.

15. The display device according to claim 14, wherein as the member for covering the external electrode, a member which performs mirror reflection or scattering reflection is used.

16. A display device wherein the display device according to claim 11 is a liquid crystal display device.
